(19) United States
(12) Patent Application Publication
(10) Pub. No.: US 2026/0212357 A1
(43) Pub. Date: Jul. 23, 2026

(54) METHODS AND SYSTEMS FOR PROVIDING ADVANCED PAYMENT SOLUTIONS UTILIZING GENERATIVE ARTIFICIAL INTELLIGENCE (AI)-BASED VOICE FINGERPRINT AUTHENTICATION TECHNOLOGY

(71) Applicant: NEXTPAYMENTS INC., Seoul (KR)

(72) Inventor: Kwang Chol JEE, Anyang-si (KR)

(21) Appl. No.: 19/399,247

(22) Filed: Nov. 24, 2025

Related U.S. Application Data
(63) Continuation of application No. PCT/KR2025/017504, filed on Oct. 29, 2025.

(30) Foreign Application Priority Data
Oct. 29, 2024 (KR) 10-2024-0149436

(51) Int. Cl. G06Q 20/40; G10L 17/18; G10L 25/63

(52) U.S. Cl. CPC G06Q 20/40145; G10L 17/18; G10L 25/63

(57) ABSTRACT

A system for providing a payment solution using generative artificial intelligence (AI)-based voice fingerprint authentication may include a memory and a processor. The processor receives and preprocess a user's voice input, extracts a voice pattern through the generative AI, and compares the extracted voice pattern with a pre-registered pattern to determine whether they match. When they match, the processor requests the user to pronounce a preset password, and analyzes the pitch, speed, and tone of the pronunciation to confirm whether the speaker is the registered user. If both the voice pattern and the password pronunciation are determined to be matched, the processor processes a payment request and controls to transmit a payment completion message to a user terminal and a payment platform.

### TECHNICAL FIELD

The present invention relates to a biometric authentication technology, and more particularly, to an advanced payment solution that allows a user to authenticate identity and perform payment without touch by combining a generative AI-based voice fingerprint and a voice keyword. This technology targets both visually impaired persons and general users, and provides security and convenience that surpass existing simple facial authentication technologies.

### BACKGROUND ART

Existing contactless payment methods are based on facial recognition or voice recognition, but these technologies have security vulnerabilities or limitations in user experience. Particularly, in the case of visually impaired persons, simple facial recognition or password input may be difficult. General users may also be exposed to security threats in the process of using a touchscreen.

A voiceprint, a technology that authenticates identity by analyzing an individual's unique voice pattern, can provide higher accuracy and security through generative AI. Furthermore, when secondary authentication is performed by inputting a keyword by voice, security can be enhanced while improving the user experience.

### SUMMARY

### Technical Problem

Therefore, the present invention has been made in. view of the above problems, an it is one object of the present invention to provide a system that allows a user to safely and quickly perform payment without touch by utilizing a generative AI-based voice fingerprint and a voice keyword. In particular, it is designed to be easily used by both visually impaired persons and general users, and focuses on maximizing user convenience while maintaining high security.

### Solution to Problem

In accordance with an aspect of the present invention, the above and other objects can be accomplished by the provision of a system for providing an advanced payment solution utilizing a generative artificial intelligence (AI)-based voice fingerprint authentication technology, the system including: a memory configured to store instructions; and a processor. When the instructions are executed by the processor, the system controls to: receive a user's voice input and preprocess it, provide the preprocessed voice data to the generative AI to extract a voice pattern, compare the extracted voice pattern with a pre-registered user's voice pattern to check whether they match, display a notification requesting to pronounce a preset password based on a match between the extracted voice pattern and the registered user's voice pattern, receive the user's pronunciation, analyze a pitch, a pronunciation speed, and a tone of the voice, and determine whether the voice belongs to the registered user based on an analysis result, process a payment request based on a match between the extracted voice pattern and the registered user's voice pattern, and based on the determination that the pronunciation for the preset password is that of the registered user, and transmit, in real time, a message indicating that the payment is completed to a user terminal and a payment platform.

When a user pronounces a command such as “Please authenticate by speaking for payment authentication”, the system collects the corresponding voice in real time and performs a preprocessing process. For example, it removes background noise and purifies the voice signal.

The generative AI analyzes the preprocessed voice data to extract the user's unique voice pattern. This pattern is compared with a pre-registered user voiceprint, and if they match, a first authentication is successfully completed.

A result of the first authentication is immediately fed back to the user, so as to allow proceeding to the next step. For example, it provides a voice message such as “The first authentication is complete. Please proceed”.

When the first authentication is completed, the system requests the user to pronounce a preset voice password. This password is not a simple word, but is composed of a unique voice pattern including the user's voiceprint.

The generative AI analyzes the input voice password to check whether the patterns of the registered voiceprint and keyword match the input voice password. In this process, the voice's unique pitch, pronunciation speed, tone, etc., are considered.

The dually protected voice authentication procedure determines not only whether the keyword pronounced by the user is simply correct, but also whether the voice is that of the actual user, and thus can effectively block attacks using recorded or forged voices.

When both the first and second authentications are completed a payment approval module operates to process the payment request. In this process, the user's payment information is protected through advanced encryption technology, and the transaction is safely completed.

### Effect of Disclosure

The present invention provides a system that allows both visually impaired persons and general users to safely perform identity authentication and payment using only voice without touch.

The advanced voiceprint and keyword authentication using generative AI provides high security, and a payment solution that enhances security while improving user experience can be implemented through a dual authentication procedure.

### BRIEF DESCRIPTION OF DRAWINGS

FIG. 1 is a diagram for explaining a system for providing an advanced payment solution utilizing a generative artificial intelligence-based voiceprint authentication technology according to an embodiment.

FIG. 2 is a block diagram illustrating the configuration of a system for providing an advanced payment solution utilizing the generative artificial intelligence (AI)-based voice fingerprint authentication technology according to an embodiment.

FIG. 3 is a flowchart illustrating a method for providing an advanced payment solution utilizing the generative artificial intelligence (AI)-based voice fingerprint authentication technology according to an embodiment.

FIG. 4 is a flowchart illustrating a method of providing an advanced payment solution utilizing the generative artificial intelligence (AI)-based voice fingerprint authentication technology according to an embodiment.

FIG. 5 is a flowchart illustrating a method of providing an advanced payment solution utilizing the generative artificial intelligence (AI)-based voice fingerprint authentication technology according to an embodiment.

### DETAILED DESCRIPTION OF EXEMPLARY EMBODIMENTS

Hereinafter, embodiments will be described in detail with reference to the accompanying drawings. However, various modifications may be made to the embodiments, and the scope of rights of this patent application is not limited or defined by these embodiments. It should be understood that all modifications, equivalents, or substitutes for the embodiments are included in the scope of rights.

Specific structural or functional descriptions of the embodiments are disclosed merely for illustrative purposes, and can be modified and implemented in various forms. Therefore, the embodiments are not limited to specific disclosed forms, and the scope of the present specification includes modifications, equivalents, or substitutes included in the technical spirit.

Terms such as ‘first’ or ‘second’ can be used to describe various components, but these terms should be interpreted only for the purpose of distinguishing one component from another. For example, the first component may be named as the second component, and similarly, the second component may also be named as the first component.

When a component is referred to as being “connected” to another component, it should be understood that it may be directly connected or coupled to the other component, but other components may be interposed therebetween.

The terms used in the embodiments are used merely for explanatory purposes and should not be interpreted as limiting. A singular expression includes a plural expression unless the context clearly indicates otherwise. In this specification, terms such as “comprise” or “have” are intended to designate the presence of stated features, numbers, steps, operations, components, parts, or combinations thereof, but it should be understood that they do not preclude the presence or addition of one or more other features, numbers, steps, operations, components, parts, or combinations thereof.

Unless otherwise defined, all terms used herein, including technical or scientific terms, have the same meaning as commonly understood by one of ordinary skill in the art to which the embodiment pertains. Terms such as those defined in commonly used dictionaries should be interpreted as having a meaning consistent with the meaning in the context of the relevant art and will not be interpreted in an idealized or excessively formal sense unless expressly so defined herein.

Further, in describing with reference to the accompanying drawings, the same components are given the same reference numerals regardless of the drawing number, and redundant descriptions thereof will be omitted. In describing the embodiments, when it is determined that a detailed description of related known art may unnecessarily obscure the gist of the embodiment, the detailed description will be omitted.

The embodiments may be implemented as various types of products, such as personal computers, laptop computers, tablet computers, smart phones, televisions, smart home appliances, intelligent automobiles, kiosks, and wearable devices.

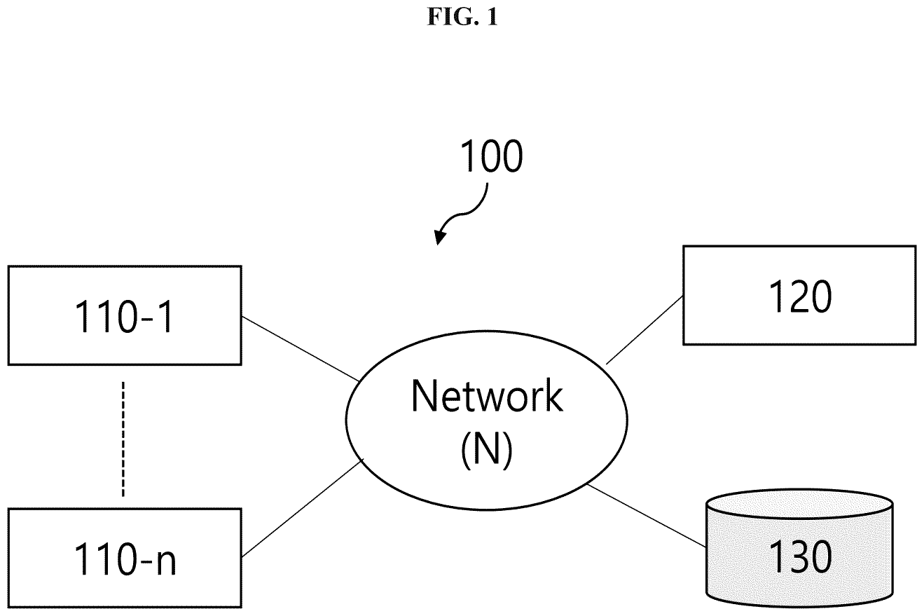

FIG. 1 is a diagram for explaining a system for providing an advanced payment solution using a generative artificial intelligence-based voiceprint authentication technology according to an embodiment.

As shown in FIG. 1, a system 100 for providing an advanced payment solution using a generative artificial intelligence-based voiceprint authentication technology may include a plurality of user terminals 110-1 to 110-n, a server 120, and a database 130. According to an embodiment, although the database 130 is illustrated as being configured separately from the server 120, the present invention is not limited thereto, and the database 130 may be provided within the server 120. For example, the server 120 may include a plurality of artificial intelligences for performing a machine learning algorithm. According to an embodiment, the plurality of user terminals 110-1 to 110-n, the server 120, and the database 130 may be connected to be communicable with each other through a network N.

The network N may perform wireless or wired communication between the plurality of user terminals 110-1 to 110-n, the server 120, the database 130, and the like. For example, the network may perform wireless communication according to methods such as Long-Term Evolution (LTE), LTE Advanced (LTE-A), Code Division Multiple Access (CDMA), Wideband CDMA (WCDMA), Wireless BroadBand (WiBro), Wireless Fidelity (WiFi), Bluetooth, Near Field Communication (NFC), Global Positioning System (GPS), or Global Navigation Satellite System (GNSS). For example, the network N may also perform wired communication according to methods such as Universal Serial Bus (USB), High Definition Multimedia Interface (HDMI), Recommended Standard 232 (RS-232), or Plain Old Telephone Service (POTS).

The database 130 may store various data. Data stored in the database 130 is data acquired, processed, or used by at least one component of the plurality of user terminals 110-1,... or the server 120, and may include software (e.g., a program). The database 130 may include volatile and/or non-volatile memory.

In the present invention, Artificial Intelligence (AI) refers to a technology that imitates human learning ability, reasoning ability, perceptual ability, etc., and implements them with a computer, and may include concepts such as machine learning and symbolic logic. Machine learning (ML) is an algorithm technology that self-classifies or learns features of input data. An AI technology is an algorithm of machine learning, and may analyze input data, learn a result of the analysis, and make a judgment or prediction based on a result of the learning. In addition, technologies that mimic functions such as cognition and judgment of the human brain by utilizing machine learning algorithms may also be understood as being in the category of AI. For example, technology fields such as linguistic understanding, visual understanding, reasoning/prediction, knowledge representation, and motion control may be included.

Machine learning may refer to processing that trains a neural network model using experience of processing data. It may mean that computer software improves its data processing ability on its own through machine learning. The neural network model is constructed by modeling a correlation between data, and the correlation may be expressed by a plurality of parameters. The neural network model derives a correlation between data by extracting and analyzing features from given data, and optimizing the parameters of the neural network model by repeating this process may be referred to as machine learning. For example, the neural network model may learn a mapping (correlation) between an input and an output for data given as input-output pairs. Alternatively, even when only input data is given, the neural network model may also derive regularity between the given data and learn the relationship.

An AI learning model or a neural network model may be designed to implement a human brain structure on a computer, and may include a plurality of network nodes that simulate neurons of a human neural network and have weights. The plurality of network nodes may have a connection relationship with each other, by simulating a synaptic activity of neurons in which neurons exchange signals through synapses. In the AI learning model, the plurality of network nodes may be located in layers of different depths and may exchange data according to a convolutional connection relationship. The AI learning model may be, for example, an artificial neural network model, a Convolution Neural Network (CNN) model, or the like. As an embodiment, the AI learning model may be machine-learned according to a method such as supervised learning, unsupervised learning, or reinforcement learning. Machine learning algorithms used to perform machine learning may include a decision tree, a Bayesian network, a support vector machine, an artificial neural network, ada-boost, a perceptron, genetic programming, clustering, and the like.

Among these, CNN is a type of multilayer perceptron designed to use minimal preprocessing. CNN consists of one or more convolutional layers and general artificial neural network layers placed on top of them, and additionally utilizes weights and pooling layers. Due to this structure, CNN may fully utilize input data of a 2D structure. Compared to other deep learning structures, CNN shows good performance in both video and audio fields. CNN may also be trained through standard backpropagation. CNN is easier to train than other feedforward artificial neural network techniques and has the advantage of using a smaller number of parameters.

Convolutional networks are neural networks that include set of nodes with tied parameters. The increase in the magnitude of available training data and the availability of computational power, combined with algorithmic advances such as piecewise linear units and dropout training, have significantly improved many computer vision tasks. On huge datasets, such as the datasets available for many tasks today, overfitting is not significant, and increasing the size of the network improves test accuracy. Optimal use of computing resources becomes a limiting factor. For this, distributed, scalable implementations of deep neural networks may be used.

A training apparatus may train a neural network to classify review responses received from the plurality of user terminals 110-1 to 110-n by item. Further, the training apparatus may train the neural network to extract a user's stay history from user movement path information. According to an embodiment, the training apparatus may be a separate entity different from the server 120, but is not limited thereto.

The neural network includes an input layer to which training samples are input, and an output layer that outputs training outputs, and may be trained based on a difference between the training outputs and labels. Here, the labels may be defined based on items corresponding to review responses, and may be defined based on the user's stay history corresponding to the movement path information. The neural network is connected as a group of a plurality of nodes, and is defined by weights between the connected nodes and an activation function that activates the nodes.

The training apparatus may train the neural network using a Gradient Descent (GD) technique or a Stochastic Gradient Descent (SGD) technique. The training apparatus may use a loss function designed by outputs and labels of the neural network.

The training apparatus may calculate a training error using a predefined loss function. The loss function may be predefined with a label, an output, and a parameter as input variables, where the parameter may be set by weights in the neural network. For example, the loss function may be designed in a Mean Square Error (MSE) form, an entropy form, or the like, and various techniques or methods may be adopted for an embodiment in which the loss function is designed.

The training apparatus may find weights affecting the training error by using a backpropagation technique. Here, the weights are relationships between nodes in the neural network. The training apparatus may use the SGD technique using the labels and the outputs to optimize the weights found through the backpropagation technique. For example, the training apparatus may update weights of the loss function defined based on the labels, the outputs, and the weights, using the SGD technique.

According to an embodiment, the training apparatus may extract first objects from a review response, acquire first labels that are items corresponding to the first objects, apply the first objects to a first neural network to generate first training outputs corresponding to the first objects, and train the first neural network based on the first training outputs and the first labels.

The training apparatus may extract second objects from movement path information, acquire second labels that are a user's stay history corresponding to the second objects, apply the second objects to a second neural network to generate second training outputs corresponding to the second objects, and train the second neural network based on the second training outputs and the second labels.

According to an embodiment, the training apparatus may generate second training feature vectors based on configuration features, length features, and pattern features of the movement path information. Various methods may be adopted for extracting the features.

According to an embodiment, the training apparatus may generate second training feature vectors based on configuration features, length features, and pattern features of the movement path information. Various methods may be adopted for extracting the features.

According to an embodiment, the training apparatus may apply the first training feature vectors to the neural network to obtain training outputs. The training apparatus may train a review item extraction algorithm of the neural network based on the training outputs and the first labels. The training apparatus may calculate training errors corresponding to the training outputs, and may train the review item extraction algorithm of the neural network by optimizing connection relationships of nodes in the neural network to minimize the training errors. The server 120 may extract items from the review response by using the first neural network whose training is completed. For example, the extracted items may include kindness, store cleanliness, service satisfaction, etc., but are not limited thereto.

According to an embodiment, the training apparatus may apply the second training feature vectors to the neural network to obtain training outputs. The training apparatus may train a user's stay history acquisition algorithm of the neural network based on the training outputs and the second labels. The training apparatus may calculate training errors corresponding to the training outputs, and may train the user's stay history acquisition algorithm of the neural network by optimizing connection relationships of nodes in the neural network to minimize the training errors. The server 120 may acquire the user's stay history from the movement path information by using the second neural network whose training is completed.

An AI model according to an embodiment may include an input layer, a hidden layer, and an output layer.

The input layer is a layer related to an input value input to the AI model.

The hidden layer may perform a Multiply-Accumulate (MAC) operation and an activation operation on the input value to output a feature map.

The MAC operation may be an operation of multiplying the input value and a corresponding weight, respectively, and summing the multiplied values.

The activation operation may be an operation of inputting a result of the MAC operation to an activation function to output a result value. The activation function may be of various types. For example, the activation function may include a sigmoid function, a tangent function, a ReLU function, a leaky ReLU function, a maxout function, and/or an ELU function, but is not limited in kind.

The hidden layer may be composed of at least one layer. For example, when the hidden layer is composed of a first hidden layer and a second hidden layer, the first hidden layer may perform a MAC operation and an activation operation based on an input value of an input system to output a feature map, and the feature map, which is a result value in the first hidden layer, may become an input value in the second hidden layer. The second hidden layer may perform a MAC operation and an activation operation based on the feature map which is the result value of the first hidden layer.

The output layer may be a layer related to a result value of the operation performed in the hidden layer.

In an embodiment, a learning model may automatically learn boundaries of compound words and entity names by learning syllable (character) patterns frequently combined and used in a given corpus, generate an object information file for learning by integrating object information of a first UI source and object information rendered in a browser, generate learning data for learning of a deep learning network using the object information file for learning, receive data of various domains of a support system, standardize the data of the various domains into an integrated format based on at least one standardization method corresponding to each of the various domains, learn and infer data of a specific domain, determine information to be delivered for the standardization in the data of the specific domain, and perform post processing on data from the various domains. The first UI source includes an XML file, the object information file for learning includes an input JSON file for learning features, and an output JSON file that is label data during learning, the output JSON file includes a file including DOM tree information of HTML implemented in compliance with web standards, the various domains include at least one of a Radio Access Network (RAN), a transport, or a core, and the post processing may include a correlation function.

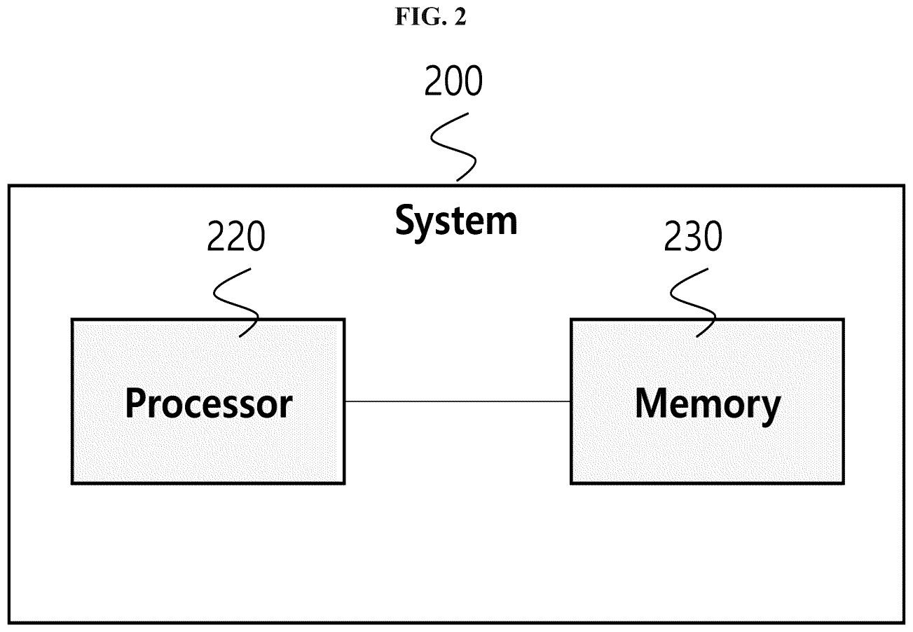

FIG. 2 is a block diagram illustrating the configuration of a system for providing an advanced payment solution utilizing a generative artificial intelligence (AI)-based voice fingerprint authentication technology according to an embodiment.

A system 200 according to an embodiment may include a processor 220 and a memory 230, and some of the illustrated components may be omitted or substituted. The system 200 according to an embodiment may be a server or a terminal. According to an embodiment. the processor 220 is a component that can perform operations or data processing related to control and/or communication of each component of the system 200, and may be composed of one or more processors. The memory 230 may store information related to the above-described method or store a program in which the above-described method is implemented. The memory 230 may be a volatile memory or a non-volatile memory. The memory 230 may store various file data, and the stored file data may be updated according to an operation of the processor 220.

According to an embodiment, the processor 220 may execute a program and control a device 400. A code of the program executed by the processor 220 may be stored in the memory 230. Operations of the processor 220 may be performed by loading instructions stored in the memory 230. The system 200 may be connected to an external device (e.g., a personal computer or a network) through an input/output device (not shown) and may exchange data.

According to an embodiment, operations and data processing functions where the processor 220 can implement on the system 200 are not be limited, but hereinafter, a function for providing an advanced payment solution using a generative artificial intelligence (AI)-based voice fingerprint authentication technology is described.

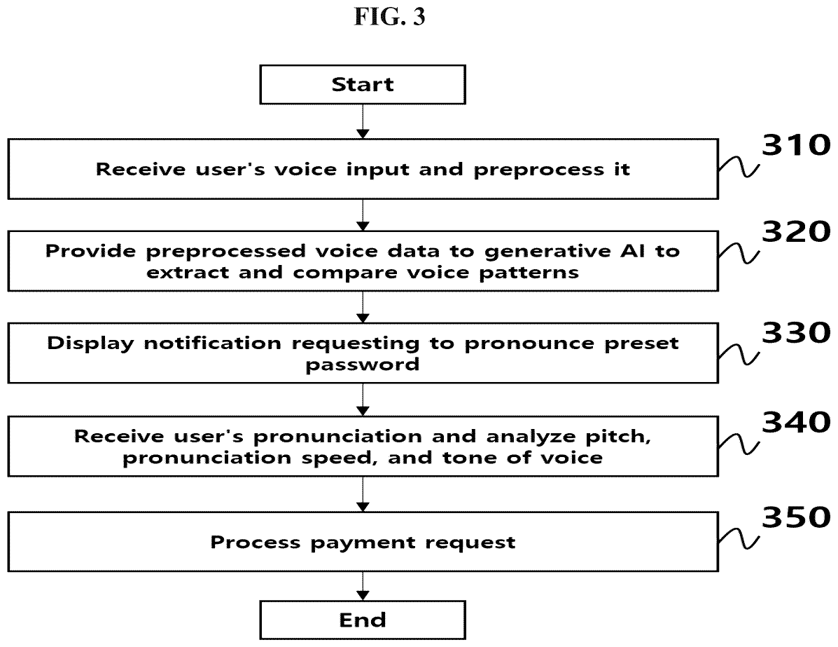

FIG. 3 is a flowchart illustrating a method of providing an advanced payment solution utilizing the generative artificial intelligence (AI)-based voice fingerprint authentication technology according to an embodiment.

Although process steps, method steps, algorithms, etc., are described in a sequential order in the flowchart of FIG. 3, such processes, methods, and algorithms may be configured to operate in any suitable order. In other words, the steps of the processes, methods, and algorithms described in the various embodiments of the present invention do not need to be performed in the order described in the present invention. Further, even if some steps are described as being performed asynchronously, these several steps may be performed simultaneously in other embodiments. Furthermore, the illustration of a process by depiction in the drawings does not mean that the illustrated process excludes other changes and modifications thereto, nor does it mean that the illustrated process or any of its steps are essential to one or more of the various embodiments of the present invention, nor does it mean that the illustrated process is desirable.

In operation 310, the system (e.g., the system 200 of FIG. 2) may receive a user's voice input and perform preprocessing, under the control of a processor (e.g., the processor 220 of FIG. 2).

For example, when a user provides a voice input, “make payment”, the system performs a preprocessing process such as removing background noise from this voice data and amplifying a voice signal. For example, when a user says “please speak for payment authentication”, the system 200 receives this voice input. Next, a preprocessing step is performed such that the voice is not affected by noise, and in this process, background noise is removed and the voice is converted into a clean form. In this way, the system clearly prepares the voice data through preprocessing.

In operation 320, the system 200 may provide the preprocessed voice data to a generative AI to extract and compare a voice pattern. The system 200 provides the preprocessed voice data to the generative AI to extract a voice pattern, and may check whether the extracted voice pattern matches a pre-registered user's voice pattern by comparing them.

From the preprocessed voice data, the generative AI analyzes features such as the user's voice tone, pronunciation habits, and voice frequency to extract the voice pattern. This extracted pattern is compared with the user's pre-registered voice pattern to check whether they match. For example, if a pattern such as “high tone, fast pronunciation speed, specific frequency stress” is stored in a voice pattern database of user A, it is compared with the pattern extracted from the inputted voice data to determine whether they match.

The preprocessed voice data is provided to the generative AI and used to extract a unique pattern of the voice. For example, if the user's voice includes a password “1234”, the generative AI analyzes this voice and generates a unique voice pattern based on the voice's frequency, pitch, pronunciation speed, and the like. Next, this pattern is compared with the user's pre-registered voice pattern to check whether they match.

In operation 330, the system 200 may display a notification requesting to pronounce a preset password. The system 200 may display a notification requesting to pronounce a preset password based on a match between the extracted voice pattern and the registered user's voice pattern.

When the system determines that the inputted voice matches the voice pattern of user A as a result of the voice pattern analysis, it displays a notification “Please pronounce the preset password for user authentication” on the user's terminal. For example, the system 200 delivers a voice notification “Please pronounce the password” to the user. The user understands the system's request and pronounces “The password is 1234”. This notification guides the user to the next step required to proceed with the authentication process.

In operation 340, the system 200 may receive the user's pronunciation and analyze the voice's pitch, pronunciation speed, and tone. The system 200 may receive the user's pronunciation, analyze the voice's pitch, pronunciation speed, and tone, and determine whether the voice belongs to the registered user's voice based on the analysis result.

When the user pronounces the password “1234”, the system analyzes the pitch (highness or lowness of sound), pronunciation speed, tone (brightness or darkness of voice), etc., from this voice data. The analysis result is compared with the password pronunciation data of user A at the time of registration to check whether they match. For example, if user A has a pattern of pronouncing “1234” with “low pitch, slow pronunciation speed, dark tone”, it is compared with the inputted pronunciation data to determine if the speaker is user A.

The system 200 receives what the user has pronounced and analyzes the pitch (highness/lowness), pronunciation speed (how fast it was spoken), and tone (voice characteristics) of this pronunciation. For example, when the user pronounces “1234”, the system analyzes the characteristics of this pronunciation and compares it with the user's voice registered in the past. If the analyzed voice is similar to the characteristics of the registered user's voice, the system determines that this voice belongs to that user.

In operation 350, the system 200 may process a payment request. The system 200 may process a payment request based on a match between the extracted voice pattern and the registered user's voice pattern and the pronunciation for the preset password being determined to be that of the registered user, and may transmit, in real time, a message indicating that the payment is completed to a user terminal and a payment platform.

When the system successfully authenticates the user by synthesizing the voice pattern comparison result and the password pronunciation analysis result, it processes the payment request. When the payment is completed, a message “Payment is complete.” is transmitted in real time to a user's smartphone and a payment platform (e.g., online shopping mall). For payment to be made, when the user's voice is confirmed, the system 200 proceeds to the step of processing the payment request. For example, when the user pronounces “the password is 1234” and this pronunciation matches the registered voice, the system processes the payment based on the user's payment information (e.g., card information). In addition, a message that the payment has been successfully completed is transmitted in real time to the user terminal and the payment platform, so the user immediately receives a payment completion notification.

In this manner, each operation proceeds sequentially, and the system provides safe and efficient payment authentication based on the user's voice.

According to an embodiment, the system 200 may may be controlled to perform voice pattern comparison using a Dynamic Time Warping (DTW) algorithm, extract a voice pattern based on time-frequency analysis of a voice signal using a generative AI, and perform liveness verification to prevent a fake attack. The preprocessing process may include steps of noise removal, normalization, and feature extraction of the voice signal, and may be characterized in that it includes a step of extracting Mel-Frequency Cepstral Coefficients (MFCC).

For example, when a user pronounces “Hello”, the system 200 compares the registered voice and the real-time voice using a DTW algorithm. DTW measures the similarity between two signals by correcting the temporal distortion of the voice pattern. The Generative AI analyzes this voice to extract features in a time-frequency domain, and through this, detects a change in a specific frequency. Further, to check whether the user's voice actually occurred through liveness verification, the system requests the user to repeat a specific sound during pronunciation, or requests various pronunciations to check whether the voice is real.

Even if the pronunciation time becomes slightly longer or shorter when user A pronounces “Payment”, the DTW algorithm is used to accurately compare the similarity with the previously registered “Payment” pronunciation pattern of user A to determine whether they match.

The Generative AI divides the voice signal into a time domain and a frequency domain for analysis. For example, in the “Payment” pronunciation, it analyzes which frequency components appear strongly over time to extract user A's own unique pronunciation pattern. This may enable more accurate voice authentication than simply comparing voice waveforms.

It verifies that it is the actual user's voice, not a recorded or synthesized voice, by having the user repeat a randomly selected specific word or read a specific sentence. For example, if the system presents the sentence “The weather is really nice today”, the user has to repeat this sentence in real time.

MFCC features reflecting human auditory characteristics are extracted from the voice signal and used for voice pattern analysis. Since MFCC represents voice data similarly to the way humans perceive sound, it may reduce the influence of background noise or emotional changes, and may enable more accurate voice authentication. For example, when a user says “Please make a payment”, the system 200 first performs noise removal to filter background noise (e.g., conversation sounds of people). Next, it normalizes the voice signal to adjust the volume constantly, and extracts MFCC to convert the frequency components of the voice into numerical values. MFCC is a feature widely used in voice recognition and plays an important role in uniquely representing a user's voice.

According to an embodiment, the system 200 may output a message “Please authenticate by speaking for payment authentication” before receiving a user's voice input, check whether an extracted voice pattern matches a registered user's voice pattern and then feed back the result to a user terminal in real time, perform analysis using a generative AI when receiving a user's pronunciation to analyze the voice's pitch, pronunciation speed, and tone, and support one or more payment methods among a credit card, electronic money, and mobile payment when processing a payment request.

For example, when a user tries to proceed with a payment, the system 200 outputs a voice message “Please authenticate by speaking for payment authentication” to guide the user through the voice recognition procedure. This message guides the user to understand the system's request and proceed to the next step. The user listens to this message and prepares to input voice. The system 200 analyzes the content pronounced by the user, compares it with a registered pattern, and then immediately delivers a message such as “Authentication successful” or “Authentication failed” to the user terminal. For example, when the user pronounces “The password is 1234” and the system analyzes this and confirms a match, it outputs a message “Authentication successful” so that the user may proceed to the next step.

The Generative AI analyzes the pitch, pronunciation speed, tone, etc., in the user's password pronunciation and compares it with the user's previously registered pronunciation pattern. For example, even if user A has a cold and their voice is different from usual, the AI may detect this change and authenticate that the speaker is user A.

The system 200 receives the content pronounced by the user, and measures the pitch of the voice through the generative AI to analyze how high-pitched the user was. In addition, it analyzes the pronunciation speed (e.g., how many words were pronounced per minute) and tone (e.g., whether it is a soft voice or a rough voice), and comprehensively evaluates all this information. For example, if the user pronounces “1234” quickly, the system confirms this and determines that the user is indeed the registered user.

When the payment is approved, the system 200 processes the payment according to a payment method selected by the user.

For example, if the user selects a credit card, the system checks the corresponding card information and proceeds with the payment. If the user selects electronic money, the system deducts the amount from an electronic money wallet. Further, when mobile payment is selected, the system processes the payment in conjunction with a mobile payment platform. In this process, the user may select a convenient method among various payment methods. The user may proceed with payment using various payment means such as a credit card, electronic money (e.g., T-money), mobile payment (e.g., KakaoPay), etc., through voice authentication.

According to an embodiment, the system 200 may control to encrypt all voiceprint data and payment information using an AES-256 encryption technique, monitor all authentication and payment activities in real time and store logs to detect abnormal activities, and control to analyze minute features of a voice pronounced by a user using the generative AI to block attacks using recorded or synthesized voices.

Important information such as the user's voice pattern data, credit card information, and payment history is securely stored using the AES-256 encryption technique. This prevents hackers from stealing or exploiting information even if they infiltrate the database.

For example, voiceprint data and payment information input by a user are encrypted through an AES-256 encryption algorithm and stored securely. In this process, the system 200 encrypts all data to protect it from external attacks. For example, even if a hacker tries to access the database, the encrypted data cannot be decrypted, thus keeping user information safe.

The system 200 observes all authentication and payment activities of the user in real time and, for example, issues an immediate warning if an abnormal pattern is found. If a user attempts payment at an unusual time, or if multiple authentication failures occur, the system records this and sends a warning message to an administrator so that additional measures can be taken.

The system 200 analyzes the user's voice to detect minute differences in the voice (e.g., minute intonation changes in pronunciation). For example, if someone attempts to authenticate by playing a recorded voice, the system detects that the voice is different from the actual user's, and rejects the authentication. In this process, the generative AI effectively blocks such attacks by analyzing the user's unique pronunciation pattern.

The system monitors all authentication attempts and payment activities of the user in real time and stores log data. For example, if multiple authentication failures occur in a short period, the system detects this as abnormal activity and temporarily locks the account to enhance security. The generative AI analyzes even very minute features of the user's voice to distinguish recorded or synthesized voices. For example, it analyzes minute noises, breathing sounds, pronunciation tremors, etc., that are difficult for humans to notice, to determine whether it is the actual user's voice.

According to an embodiment, the system 200 may detect ambient noise when receiving the user's voice input, and request re-input from the user if a noise level exceeds a preset threshold, analyze an emotional state during extraction of the user's voice pattern, and perform an additional confirmation procedure if a stress or coercion situation is detected, receive input through multiple microphones when receiving the user's voice input, and analyze a direction and distance of the voice to confirm an actual user's location, and compare and analyze a user's usual payment pattern and a current payment content when processing a payment request to detect an abnormal transaction, and request additional authentication if necessary.

When a user attempts to make a payment by voice on a noisy roadside, the system detects the ambient noise, and if it determines the noise level is too high, it displays a message “Ambient noise is too loud. Please try again in a quiet place.” and requests voice re-input. If emotions such as anxiety, tension, or fear are detected in the user's voice, the system presents a message “Please answer additional questions for identity verification” along with an additional question (e.g., What is your mother's name?) to block payment attempts due to coercion.

It receives voice input through multiple microphones built into a smartphone, and analyzes the direction and distance of the voice to identify the actual user's location. For example, authentication is allowed only when the user's voice is heard within a distance of 1 m from the smartphone and input from the front direction, thereby preventing fraudulent payments using a stolen smartphone. If a user who usually makes payments of 100,000 KRW or less at online shopping malls suddenly tries to pay for an expensive product of 1 million KRW or more, the system detects this as an abnormal transaction and requests additional authentication. For example, it displays a message “Please complete fingerprint authentication.” to strengthen identity verification.

For example, when a user pronounces “Please speak for payment authentication”, the system 200 detects ambient noise in real time, and if the noise level exceeds 60 dB, outputs a message “Noise is too loud. Please speak again” to request the user to re-input in a quiet environment. When the user pronounces a password, the system analyzes the pitch and speed of the voice to determine the user's emotional state. For example, if the user pronounces “1234” in a nervous voice, the system detects this as a sign of stress and requests an additional confirmation procedure, “Please pronounce again in a more comfortable environment”.

The system 200 uses multiple microphones to receive the user's voice and analyzes from which direction the voice is coming. For example, if the user pronounces from a location close to the system, the system processes this voice preferentially and confirms the user's identity based on the information “User is pronouncing at a close location”. The system 200 analyzes the user's past payment history, and for example, if a user who makes payments of 50,000 KRW or less on average attempts a payment of 500,000 KRW, it outputs a message “Abnormal transaction detected. Please proceed with additional authentication” to request additional authentication.

According to an embodiment, the system 200 may improve authentication accuracy by considering characteristics by age group during analysis of the user's voice pattern, periodically update the user's voice pattern data, and learn voice changes over time to maintain authentication accuracy, prevent the use of pre-recorded voice by randomly requesting a specific word or phrase during the user's voice input and checking a real-time response, and provide a backup authentication method in case of the user's voice authentication failure, wherein the method is automatically selected according to the user's physical characteristics or situation.

In the case of the elderly, pronunciation is often inaccurate or the voice trembles, so the system adjusts the voice pattern analysis algorithm considering these age-specific characteristics and increases authentication accuracy. For example, when analyzing the voice patterns of people in their 20 s and 60 s, the system 200 learns the voice characteristics of each age group and adjusts to more accurately recognize the lower voice of a user in their 60 s. The system 200 analyzes the user's voice annually to reflect changing voice characteristics. For example, if the user's voice tone lowers as they age, the system detects this and registers a new voice pattern to increase the accuracy of authentication. The system 200 randomly requests “Please say the specific phrase ‘Hello’” when the user says “Please enter your password”. It verifies whether pre-recorded voice is being used by checking if the user can respond immediately to this phrase.

For example, if the user fails voice authentication, the system outputs a message “Would you like to authenticate with fingerprint recognition?”, suggesting an additional authentication method considering the user's physical characteristics (whether fingerprint recognition is possible). If the user is in a situation where fingerprint recognition is not possible, the system automatically presents an alternative method, “Please enter your password”.

As the user's voice may change over time, the system periodically (e.g., every 3 months) requests the user to update voice data, and learns the new voice data to maintain authentication accuracy. During user authentication, the system displays a random word or phrase, which cannot be pre-recorded, on the screen, such as “Please read the number you see now”, and checks the user's real-time response to prevent a recorded voice playback attack. If the user loses their voice and fails voice authentication, the system provides a backup authentication method suitable for the situation by automatically presenting fingerprint authentication if the user's smartphone has a fingerprint recognition sensor, or facial authentication if it has a facial recognition camera.

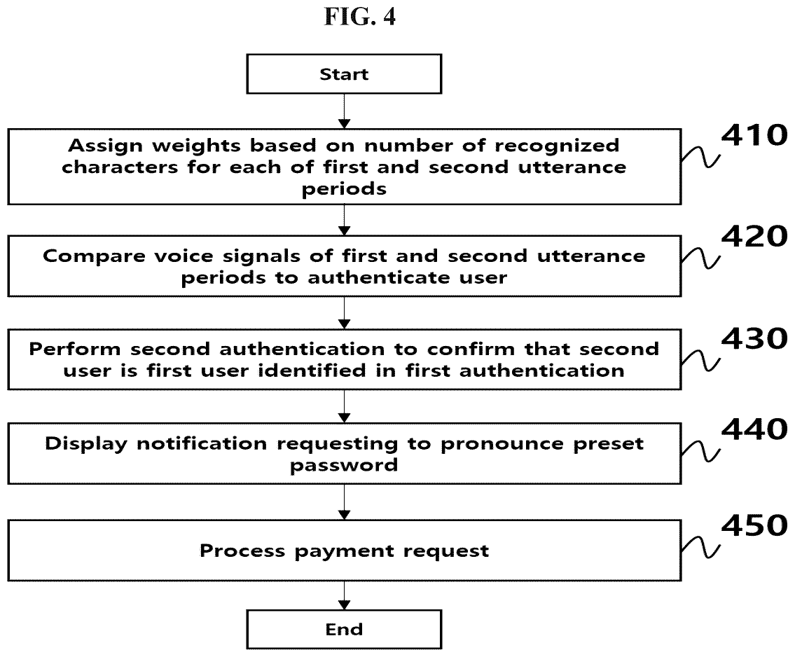

FIG. 4 is a flowchart illustrating a method of providing an advanced payment solution utilizing the generative artificial intelligence (AI)-based voice fingerprint authentication technology according to an embodiment.

Although process steps, method steps, algorithms, etc., are described in a sequential order in the flowchart of FIG. 4, such processes, methods, and algorithms may be configured to operate in any suitable order. In other words, the steps of the processes, methods, and algorithms described in the various embodiments of the present invention do not need to be performed in the order described in the present invention. Further, even if some steps are described as being performed asynchronously, these several steps may be performed simultaneously in other embodiments. Furthermore, the illustration of a process by depiction in the drawings does not mean that the illustrated process excludes other changes and modifications thereto, nor does it mean that the illustrated process or any of its steps are essential to one or more of the various embodiments of the present invention, nor does it mean that the illustrated process is desirable.

In operation 410, a system (e.g., the system 200 of FIG. 2) may assign a weight based on the number of characters recognized for each of a first utterance period and a second utterance period, under the control of a processor (e.g., the processor 220 of FIG. 2). The system 200 may assign a weight based on the number of characters recognized for each of a first utterance period and second utterance period of a voice signal, calculate a total number of characters of the first utterance period and the second utterance period, and adjust a weight of the first utterance period according to a ratio of a first character count to the total number of characters.

For example, when a user pronounces “Hello” in the first utterance, the system counts the characters recognized in this utterance and records that 5 characters were recognized. If the user says “Nice to meet you” in the second utterance, the number of characters recognized in this utterance becomes 6. At this time, the system may calculate the total number of characters as 11, and adjust the weight of the first utterance to 5/11.

In operation 420, the system 200 may authenticate the user by comparing the voice signals of the first utterance period and the second utterance period. The system 200 may adjust a weight of the second utterance period according to a ratio of a second character count to the total number of characters, wherein an authentication apparatus authenticates the user by comparing the voice signals of the first utterance period and second utterance period to which the weights are applied, detect a noise period in the voice signals of the first utterance period and the second utterance period, perform authentication by performing comparison after deleting the detected noise period, and perform a first authentication that identifies a first user by an authentication method different from voice authentication.

For example, if the voice recognized in the first utterance is “Hello” and the voice recognized in the second utterance is “Nice to meet you”, the system compares the two voices to evaluate similarity. Here, the weight of the second utterance is adjusted to 6/11, and the authentication apparatus proceeds with authentication by comparing the two voices to which the weights are applied. Further, the system detects a noise period, and for example, if the user spoke in an environment with ambient noise, it analyzes and removes this noise, and performs authentication by comparing only the remaining voice signals.

For example, if a user first pronounces “One hundred thousand KRW from my account” (first utterance period), and, after a moment, pronounces “Transfer to Hong Gil-dong” (second utterance period), the system calculates the number of characters recognized in each utterance period. 10 characters (“Onehundredthousandkrwfrommyaccount”) were recognized in the first utterance period, and 7 characters (“TransfertoHongGildong”) were recognized in the second utterance period. The total number of characters is 17, and the weight of the first utterance period is calculated as 10/17, and the weight of the second utterance period is calculated as 7/17. That is, a higher weight is assigned to the first utterance period with more characters.

The weights (first: 10/17, second: 7/17) calculated in the above example are applied to the voice signal of each utterance period for comparison. That is, the voice signal of the first utterance period is reflected in the comparison with a greater weight. If a sudden loud noise occurred during the second utterance period, the system detects this as noise and compares only the remaining voice signal, except for that part, with the voice signal of the first utterance period. When the user selects “Login with voice” through a smartphone app, a first authentication is first performed through password input. After successful password authentication, it proceeds to a voice authentication step.

In operation 430, the system 200 may perform a second authentication that confirms that a second user is the first user identified in the first authentication. The system 200 may obtain a registered first voice of the first user identified in the first authentication from a server separate from the system, but does not obtain registered voices of other users, receive a second voice spoken by the second user during operation and preprocess it, provide the preprocessed second voice data to the generative AI to extract a voice pattern, perform a second authentication that confirms that the second user is the first user identified in the first authentication by comparing features of the extracted second voice and features of the first voice, but does not compare with other registered voices, and when the second authentication is successfully completed, perform a process according to an operation associated with the second voice.

For example, the system obtains the registered voice of the first user from a separate server and ignores the voices of other users. Next, when the second user pronounces “Hello”, the system preprocesses this voice, for example, removes noise and purifies the voice data. The purified voice data is provided to the generative AI to extract a voice pattern, and then compared with the voice of the first user. In this process, if it is determined that the second user's voice is similar to the first user's voice, the second authentication is successfully completed, and thereafter, a specific operation associated with the second voice is performed.

Using the ID information of the user who passed the first authentication (password authentication), the system 200 loads only the voice data of the corresponding user stored in the server. It does not access the voice data of other users. The system requests voice input from the user with the guide “Please say ‘Have a nice day today’ for identity verification”. It receives the user's voice input and compares it with the corresponding user's voice data loaded from the server to check whether they match. At this time, personal information protection is strengthened by comparing it only with the voice data of the corresponding user and not with the voice data of other users. Upon successful completion of the second authentication (voice authentication), the “Login with voice” operation requested by the user is performed.

In operation 440, the system 200 may display a notification requesting to pronounce a preset password. When performing a process according to an operation associated with the second voice, the system 200 may perform the process using the corresponding several setting values and other predetermined setting values if the second voice is associated with an operation of setting some of a plurality of setting values, transmit the second voice to a server that performs a voice recognition process, only when the second authentication is successfully completed, consider the second authentication as successfully completed if features of the second voice include features of the first voice, and display a notification requesting to pronounce a preset password based on a match between the extracted second voice pattern and the registered voice pattern of the first user.

When the user's voice command “Turn on the air conditioner” is executed, the system first checks setting values (e.g., temperature, air volume) related to the operation of turning on the air conditioner. If the user only says “Turn on the air conditioner” and does not specify the temperature or air volume, the system turns on the air conditioner using predetermined default setting values (e.g., temperature of 24 degrees, medium air volume).

If the user's voice command is not simply an operation of turning a device on or off, but includes a task related to personal information (e.g., account transfer, personal information inquiry), the system transmits the user's voice data to the server to perform the voice recognition process only after the second authentication (voice authentication) is successfully completed.

The system considers the second authentication to be successfully completed if the voice pattern extracted from the user's voice data is similar to the user's previously registered voice pattern. For example, if the user's pronunciation, intonation, speaking speed, etc., match the existing data, the authentication is successful.

After voice authentication, the system may additionally request password pronunciation to enhance security. For example, it displays a message “Please say your password for payment” and receives the user's password pronunciation.

The system displays a notification requesting to pronounce a preset password. For example, after the user is successfully authenticated, the system displays a message “Please pronounce the password” on the screen. At this time, if the second voice is related to the operation of setting some of a plurality of setting values, the system performs the process by combining the corresponding setting values and other predetermined setting values. If the user pronounces “The 2023 password is secret”, the system analyzes this voice, and transmits this voice to the server that performs the voice recognition process only when the second authentication is successfully completed. The system considers the second authentication to be successfully completed if the voice pattern extracted from the user's voice data is similar to the user's previously registered voice pattern. The system evaluates whether the features of the second voice include the features of the first voice, and if it is determined that these two voices are similar, displays a notification to pronounce a password.

In operation 450, the system 200 may process a payment request. The system 200 may receive the user's pronunciation, analyze the pitch, pronunciation speed, and tone of the voice, and determine whether the voice belongs to the registered user based on an analysis result, process a payment request based on a match between the extracted voice pattern and the registered user's voice pattern and based on the determination that the pronunciation for the preset password is that of the registered user, and transmit, in real time, a message indicating that the payment is completed to a user terminal and a payment platform.

When the user pronounces the password “7890”, the system 200 analyzes the highness/lowness of the voice (pitch), pronunciation speed, brightness/darkness (tone), etc., and compares it with the user's previously registered password pronunciation data. When the system 200 successfully authenticates the user by synthesizing the voice pattern comparison and password pronunciation analysis results, it processes the payment request.

For example, if the user gives a voice command “Pay 50,000 KRW with Samsung Pay” and authentication is successful, the system 200 proceeds with the 50,000 KRW payment through Samsung Pay. When the payment is completed, a message “Payment is complete” is displayed on the user's smartphone screen, and at the same time, payment completion information is transmitted in real time to a payment platform (e.g., online shopping mall).

When the user pronounces “Please make a payment”, the system receives this voice and analyzes its pitch, pronunciation speed, and tone. For example, if the user pronounces in a tone similar to the user's usual voice, the system checks whether this voice belongs to the registered user. If the extracted voice pattern matches the registered user's voice pattern and it is determined that the user has pronounced the preset password correctly, the system processes the payment request. When the payment is completed, a message “Payment is complete” is transmitted in real time to the user terminal and the payment platform to inform the user of the result.

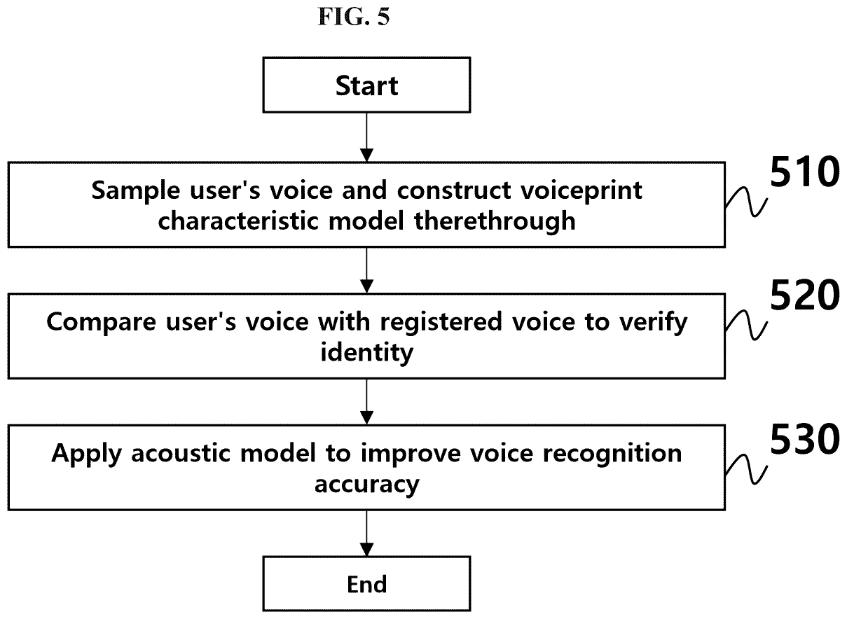

FIG. 5 is a flowchart illustrating a method of providing an advanced payment solution utilizing the generative artificial intelligence (AI)-based voice fingerprint authentication technology according to an embodiment.

Although process steps, methods steps, algorithms, etc., are described in a sequential order in the flowchart of FIG. 5, such processes, methods, and algorithms may be configured to operate in any suitable order. In other words, the steps of the processes, methods, and algorithms described in the various embodiments of the present invention do not need to be performed in the order described in the present invention. Further, even if some steps are described as being performed asynchronously, these several steps may be performed simultaneously in other embodiments. Furthermore, the illustration of a process by depiction in the drawings does not mean that the illustrated process excludes other changes and modifications thereto, nor does it mean that the illustrated process or any of its steps are essential to one or more of the various embodiments of the present invention, nor does it mean that the illustrated process is desirable.

In operation 510, a system (e.g., the system 200 of FIG. 2) may sample a user's voice and build a voiceprint characteristic model therethrough, under the control of a processor (e.g., the processor 220 of FIG. 2). The system 200 may sample a user's voice and build a voiceprint characteristic model therethrough, and identify an origin of the voice based on voice data collected from the current user.

For example, when a user pronounces “Hello, I am a user”, the system samples this voice and analyzes the voice's frequency, pitch, tone, etc. Based on the voice data collected in this way, the system models the user's voice characteristics, and through this, may identify what characteristics the corresponding user's voice has. This voiceprint characteristic model is used to recognize the user's unique voice.

When the user presses a “Voice Registration” button and says “Hello. I am Hong Gil-dong.”, the system samples the voice inputted through a microphone at regular time intervals and converts it into digital data. The system extracts the user's unique features such as tone, intonation, and pronunciation habits from the sampled voice data to generate a voiceprint characteristic model. For example, it analyzes a specific frequency pattern that appears when pronouncing “Ah”, a change in intonation that appears in the sentence “Hello”, etc., and stores them in the model.

The system analyzes the collected voice data to identify the origin of the voice, such as whether the voice was input from the smartphone's own microphone, input through an external Bluetooth device, or played from a recorded file.

In operation 520, the system 200 may compare the user's voice with the registered voice to verify identity. For example, when a user pronounces “I will make a payment”, the system compares this voice with the registered voice to evaluate similarity. If the two voices are similar, the system confirms that the user is the registered user, and proceeds with authentication. In this process, identity is determined by analyzing the pitch, speed, and nuance of pronunciation of the voice.

When a user attempts voice authentication, the system compares the currently input voice with the previously registered voiceprint characteristic model to check if the user is the same. For example, when the user says “Make payment”, the system analyzes the pronunciation, intonation, tone, etc., calculates the similarity with the registered model, and determines that the user is the same if they match above certain thresholds.

In operation 530, system 200 may apply an acoustic model to improve the accuracy of voice recognition. The system 200 may improve the accuracy of voice recognition by applying an acoustic model composed of a sampling convolutional layer, an intermediate layer, an attention pooling layer, a segment layer, and a SoftMax classification layer. The sampling convolutional layer may include a plurality of sampling bandpass filters, each voice frame may be configured to be converted into a bandpass signal of a plurality of channels, the bandpass signal may be configured to be output as a T-frame level vector through the intermediate layer, the attention pooling layer may configured to be transform the T-frame level vector into a 1-frame vector through an attention introduction mechanism, and the 1-frame vector may be configured to be transmitted to the SoftMax classification layer via the segment layer.

The sampling bandpass filter may include two learnable parameters having a high cutoff frequency and a low cutoff frequency. The shape of the filter is characterized by being defined by: g[n, f1, f2]=2f2sinc(2πf2n)-2f1sinc(2πf1n)

Here, n means a sampling point, f1 means a low-frequency cutoff frequency of the bandpass filter, and f2 means a high-frequency cutoff frequency of the bandpass filter.

For example, the sampling convolutional layer includes several sampling bandpass filters and converts the user's voice into a bandpass signal of a plurality of channels. At this time, each voice frame is processed through the filter and output as a T-frame level vector in the intermediate layer. Next, the attention pooling layer transforms this vector into a single-frame vector through an attention mechanism, and the transformed vector is transmitted to the SoftMax classification layer via the segment layer.

The sampling bandpass filter includes two learnable parameters having a high cutoff frequency and a low cutoff frequency. For example, assuming that f1 is 300 Hz and f2 is 3400 Hz, the filter passes only signals in a specific frequency range and blocks the rest, thereby improving the quality of the voice signal. The shape of the filter is defined as g[n, f1, f2]=2f2sinc(2πf2n) 2f1sinc(2πf1n), where n represents a sampling point. Through this formula, the characteristics of the filter are calculated to enable more precise voice recognition.

It receives voice data and applies several sampling bandpass filters to the data. Each filter is designed to pass only signals of a specific frequency band. For example, a voice signal is separated into several frequency bands using a filter that passes a frequency band of 100 Hz~500 Hz, a filter that passes a frequency band of 500 Hz~1000 Hz, etc.

Signals passed through each filter are analyzed and converted into a vector composed of T frames. Each frame represents voice information of a specific time interval. Only important information is extracted from the T frame vectors and compressed into one frame vector. For example, in the pronunciation of the word “Payment”, if the “pay” part is more important for user identification than the “ment” part, a higher weight is given to the frame corresponding to the “ment” part. One frame vector is divided into phoneme units. For example, the word “Payment” is divided into phoneme units such as “p”, “a”, “y”, “m”, “e”, “n”, and “t”. The SoftMax classification layer classifies each phoneme and recognizes which word was finally pronounced.

In the sampling bandpass filter, each filter plays the role of passing a specific frequency band. For example, the g[n, 100, 500] filter passes only signals in the 100 Hz~500 Hz frequency band. The shape of the filter is defined as g[n, f1, f2]=2f2sinc(2πf2n)-2f1sinc(2πf1n), and it produces an effect of smoothly cutting off a specific frequency band by using a sinc function.

According to an embodiment, the system 200 may, for a voiceprint signal, remove silent sections through voice activity detection and preserve valid voice sections, divide the valid voice sections into voice sections of equal length, perform a short-time Fourier transform of each voice signal to generate a spectrogram matrix S_i, and perform differencing according to a time order of the spectrogram matrix to generate a difference matrix D_i.

For example, while a user pronounces “Hello”, the system detects the start and end points of this voice, and removes the “...” part which is a silent section. Then, it divides the valid voice section into voice sections of equal length. If the entire utterance is 3 seconds, it is divided by 1 second each to be split into 3 voice sections. For each voice signal, a short-time Fourier transform is performed to generate a spectrogram matrix S_i. In this process, the voice of the first 1-second section, for example, is transformed to generate data visualized in the form of a spectrogram. Next, differencing is performed according to the time order of the generated spectrogram matrix to generate a difference matrix D_i. This difference matrix visually represents a change in voice and contributes to improving the accuracy of voice recognition.

For example, while a user starts “Voice Authentication” and says “Password 1234”, the system removes preceding and trailing silent sections through voice activity detection, leaving only the “Password 1234” pronunciation section. The system 200 divides the “Password 1234” pronunciation section into 0.1-second-long voice sections.

The system 200 performs a short-time Fourier transform (STFT) on each 0.1-second-long voice section to analyze frequency components that change over time, and generates a spectrogram matrix S_i that visually represents this. Each row of the S_i matrix represents a time frame, and each column represents a frequency component. The value in the matrix represents the intensity of the corresponding frequency component in the corresponding time frame. The system 200 generates a difference matrix D_i by calculating a difference between adjacent frames according to the time order of the spectrogram matrix S_i. This is to more clearly analyze the change of the voice signal over time. For example, a change in spectrogram between the pronunciation of “1” and the pronunciation of “2” is analyzed and stored in the difference matrix.

According to an embodiment, the system 200 is configured to set a threshold, compare values of respective coordinates, and then convert it into a pulse matrix to be used as an input of a pulse neural network. When a user inputs a voice signal, the system 200 authenticates identity using the voiceprint signal, and if authentication is passed, it grants authority to execute a corresponding command. If authentication fails, it provides an interface onto a user terminal to select whether to be a new user, and, if no user input is received, it may deny access from the system.

For example, when the system analyzes spectrogram data of a voice signal, it determines whether a value in a specific frequency range exceeds a set threshold. When the user inputs a voice signal, the system authenticates the identity based on this voiceprint signal. If the authentication is passed, the user is granted authority to execute a specific command. For example, if the user pronounces “Payment”, the system recognizes this and allows the payment process to proceed. Conversely, if authentication fails, an interface is provided on the user terminal to select whether to be a new user. At this time, if the user wants to register as a new user, the user may click a “New User Registration” button. If the user does not provide any input, the system controls to deny access, thereby increasing security.

The system 200 compares each coordinate value of the difference matrix D_i with a preset threshold, and generates a pulse matrix by converting it to 1 if it is greater than the threshold and to 0 if it is smaller. This pulse matrix is used as an input to a Pulse Neural Network (SNN).

When the user says the voice command “Make a call”, the system 200 inputs the pulse matrix, generated through the above process, into the pulse neural network to authenticate the user. The pulse neural network is a neural network that processes information in the form of pulses, is energy efficient, and is suitable for real-time processing. If voice authentication is successful, the system grants authority to the user to execute the “Make a call” command. If voice authentication fails, the system displays a message “Registered user not found. Would you like to register as a new user?” on the smartphone screen to allow the user to select whether to register as a new user. If the user does not select new registration, the system 200 displays a message “Voice authentication failed. Access denied.” and blocks access to the corresponding function.

According to an embodiment, the system 200 may receive a dynamic authentication character generated according to a user's voice payment request. The dynamic authentication character is randomly selected from a fixed-length character data template and transmitted to the user. The system 200 may provide guide information to the user, collect a voice input including voice information corresponding to user information and the dynamic authentication character, display a message to the user to perform voice input before collecting the voice input, and display a message to the user to select and confirm multiple pronunciations when collecting the voice input.

For example, when a user says “Payment request”, the system detects this request and generates a dynamic authentication character. This dynamic authentication character is randomly selected from a fixed-length character data template and transmitted to the user. For example, the system selects an authentication character “ABC123” and transmits it to the user. Next, the system provides guide information “Please perform voice input now” to the user. The user prepares to provide a voice input including the user's own voice information. Before collecting the voice input, the system displays a message, “Please tell me when you are ready before inputting voice”. When collecting the voice input, the system displays an additional message “Please select and confirm multiple pronunciations” to the user, guiding the user to select from several pronunciations such as, for example, “Payment” or “Cancel”.

For example, if a user requests “Pay 50,000 KRW with OO Pay” by voice, the system receives the payment request and generates a dynamic authentication character such as “7835”. At this time, the dynamic authentication character is generated by randomly selecting 4 characters from a pre-stored fixed-length character data template “0123456789”.

The system displays the generated dynamic authentication character “7835” on the user's smartphone screen and provides a guide message such as “Please read the numbers displayed on the screen”. When the user pronounces “Seven Eight Three Five” according to the guide message, the system collects the voice input through a microphone. Before collecting the voice input, the system displays a message such as “Touch the screen to start voice input” to guide the voice input method to the user. If there is a character that can be pronounced in several ways, such as “Three”, the system displays a message such as “Which pronunciation would you like to select? 1) Three 2) Tree” to allow the user to select the desired pronunciation.

According to an embodiment, the system 200 may display a message to the user to confirm an input result after collecting a voice input, perform identity authentication and voiceprint authentication according to the voice input including voice information corresponding to a dynamic authentication character and user information, confirm the user's bank card information, and if the identity authentication and the voiceprint authentication are passed, acquire seller's information and a transaction amount, perform payment verification by inputting a password, and if the payment verification is passed, cause the transaction amount to be paid to a seller corresponding to the seller's information.

For example, when the user pronounces “Payment request”, the system displays a message “Is the input content correct? Would you like to confirm as ‘Payment request’?”. Next, the system performs identity authentication and voiceprint authentication according to the voice input including the voice information corresponding to the dynamic authentication character and the user information. In this process, the system confirms the identity by comparing the user's voice data with the registered voice data, and confirms the user's bank card information. If the identity authentication and voiceprint authentication are passed, the system acquires seller's information and a transaction amount. For example, if the transaction amount is 50,000 KRW, the system provides guidance “The transaction amount is 50,000 KRW” based on this information. Next, the user inputs a password to verify the payment, and the system performs payment verification after confirming whether this password is correct. If the payment verification is passed, the system causes the transaction amount to be paid to the seller corresponding to the seller's information. For example, it outputs a message “Paying 50,000 KRW to Seller A” and completes the transaction.

When the user's voice input is finished, the system displays a message such as “The input number is 7835. Is this correct?” to allow the user to confirm the input result. The system verifies the user's identity using the voiceprint information extracted from the user's voice. For example, it analyzes the tone, pronunciation habits, frequency features, etc., of the voice and compares them with the user's previously registered voice data. The system checks the user's bank card information to verify whether it is a valid card, whether the balance is sufficient, and the like. If the identity authentication and the voiceprint authentication are passed, the system acquires the seller's information and the transaction amount from the user's payment request information. For example, from the request “Pay 50,000 KRW with OO Pay”, it extracts the seller's information “OO Pay” and the transaction amount “50,000 KRW”.

The system requests the user to input a payment password and performs a payment verification process of checking whether the inputted password matches. When the payment verification is completed, the system transmits the transaction amount to the corresponding seller. For example, it transmits the 50,000 KRW payment information to the OO Pay system.

1. A system for providing an advanced payment solution utilizing a generative artificial intelligence (AI)-based voice fingerprint authentication technology, the system comprising:
a memory configured to store instructions; and
a processor,
wherein, when the instructions are executed by the processor, the system controls to:
receive a user's voice input and preprocess it,
provide the preprocessed voice data to the generative AI to extract a voice pattern,
compare the extracted voice pattern with a pre-registered user's voice pattern to check whether they match,
display a notification requesting to pronounce a preset password based on a match between the extracted voice pattern and the registered user's voice pattern,
receive the user's pronunciation, analyze a pitch, pronunciation speed, and tone of the voice, and determine whether the voice belongs to the registered user based on an analysis result,
process a payment request based on a match between the extracted voice pattern and the registered user's voice pattern, and based on a determination that a string recognized from the user's pronunciation matches with a numeric string of the preset password and that a voice pattern of the corresponding password pronunciation is confirmed as that of the registered user, and
transmit, in real time, a message indicating that the payment is completed to a user terminal and a payment platform.

2. The system according to claim 1, wherein, when the instructions are executed by the processor, the system controls to:
perform voice pattern comparison using a Dynamic Time Warping (DTW) algorithm,
extract a voice pattern based on time-frequency analysis of the voice signal using the generative AI, and
perform liveness verification to prevent a fake attack,
wherein the preprocessing process comprises noise removal, normalization, and feature extraction steps for the voice signal, and comprises a step of extracting Mel-Frequency Cepstral Coefficients (MFCC).

3. The system according to claim 1, wherein, when the instructions are executed by the processor, the system controls to:
output a message “Please authenticate by speaking for payment authentication” before receiving the user's voice input,
check whether the extracted voice pattern matches the registered user's voice pattern and then feed back the result to a user terminal in real time,
perform analysis using the generative AI when receiving the user's pronunciation to analyze the voice's pitch, pronunciation speed, and tone, and
support one or more payment methods among a credit card, electronic money, and mobile payment when processing the payment request.

4. The system according to claim 1, wherein, when the instructions are executed by the processor, the system controls to:
encrypt all voiceprint data and payment information using an AES-256 encryption technique,
monitor all authentication and payment activities in real time and store logs to detect abnormal activities, and
analyze minute features of a voice pronounced by a user using the generative AI to block attacks using recorded or synthesized voices.

5. The system according to claim 1, wherein, when the instructions are executed by the processor, the system controls to:
detect ambient noise when receiving the user's voice input, and request re-input from the user if a noise level exceeds a preset threshold,
analyze an emotional state during extraction of the user's voice pattern, and perform an additional confirmation procedure if a stress or coercion situation is detected,
receive input through multiple microphones when receiving the user's voice input, and analyze a direction and distance of the voice to confirm an actual user's location, and
compare and analyze a user's usual payment pattern and a current payment content when processing a payment request to detect an abnormal transaction, and request additional authentication if necessary.

6. The system according to claim 1, wherein, when the instructions are executed by the processor, the system controls to:
improve authentication accuracy by considering characteristics by age group during analysis of the user's voice pattern,
periodically update the user's voice pattern data, and learn voice changes over time to maintain authentication accuracy,
prevent use of a pre-recorded voice by randomly requesting a specific word or phrase during the user's voice input and checking a real-time response, and
provide a backup authentication method when the user's voice authentication fails, and ensure the method to be automatically selected according to the user's physical characteristics or situation.

7. The system according to claim 1, wherein, when the instructions are executed by the processor, the system controls to:
assign a weight based on the number of characters recognized for each of a first utterance period and second utterance period of the voice signal,
calculate a total number of characters of the first utterance period and the second utterance period,
adjust a weight of the first utterance period based on a ratio of a first character count to the total number of characters,
adjust a weight of the second utterance period based on the ratio of a second character count to the total number of characters, wherein an authentication apparatus authenticates the user by comparing the voice signals of the first and second utterance periods to which the weights are applied,
detect a noise period in the voice signals of the first utterance period and the second utterance period, and perform authentication by comparing after deleting the detected noise period,
perform a first authentication that identifies a first user by an authentication method different from voice authentication,
obtain a registered first voice of the first user, identified in the first authentication, from a server separate from the system, but not obtain registered voices of other users, and receive a second voice spoken by a second user during operation and preprocess the second voice,
provide the preprocessed second voice data to the generative AI to extract a voice pattern,
perform a second authentication that confirms that the second user is the first user identified in the first authentication by comparing features of the extracted second voice and features of the first voice, but not compare with other registered voices, and perform a process according to an operation associated with the second voice when the second authentication is successfully completed,
if the second voice is associated with an operation of setting some of a plurality of setting values when performing the process according to the operation associated with the second voice, perform the process using the corresponding several setting values and other predetermined setting values,
transmit the second voice to a server that performs a voice recognition process, only when the second authentication is successfully completed,
consider the second authentication as successfully completed if features of the second voice comprise features of the first voice, and display a notification requesting to pronounce a preset password based on a match between the extracted second voice pattern and the registered voice pattern of the first user,
receive the user's pronunciation, analyze a pitch, a pronunciation speed, and a tone of the voice, and determine whether the voice belongs to the registered user based on an analysis result,
process a payment request based on a match between the extracted voice pattern and the registered user's voice pattern, and based on a determination that the pronunciation for the preset password is that of the registered user, and
transmit, in real time, a message indicating that the payment is completed to a user terminal and a payment platform.

8. The system according to claim 1, wherein, when the instructions are executed by the processor, the system:
samples a user's voice and builds a voiceprint characteristic model therethrough, and identifies an origin of the voice based on voice data collected from the current user,
verifies identity by comparing the user's voice with a registered voice through a voice recognition function, and
improves accuracy of voice recognition by applying an acoustic model composed of a sampling convolutional layer, an intermediate layer, an attention pooling layer, a segment layer, and a SoftMax classification layer,
wherein the sampling convolutional layer comprises a plurality of sampling bandpass filters,
each voice frame is converted into a bandpass signal of a plurality of channels,
the bandpass signal is output as a T-frame level vector through the intermediate layer,
the attention pooling layer transforms the T-frame level vector into a 1-frame vector through an attention introduction mechanism, and the 1-frame vector is configured to be transmitted to the SoftMax classification layer via the segment layer,
wherein each of the sampling bandpass filters comprises two learnable parameters having a high cutoff frequency and a low cutoff frequency,
wherein a shape of the filter is defined by:
g[n, f1, f2]=2f2sinc(2πf2n)-2f1sinc(2πf1n)
where n is a sampling point, f1 is a low-frequency cutoff frequency of the bandpass filter, and f2 is a high-frequency cutoff frequency of the bandpass filter.

9. The system according to claim 1, wherein, when the instructions are executed by the processor, the system:
for a voiceprint signal, removes silent sections through voice activity detection and preserves valid voice sections,
divides the valid voice sections into voice sections of equal length,
performs a short-time Fourier transform of each voice signal to generate a spectrogram matrix S_i,
performs differencing according to a time order of the spectrogram matrix to generate a difference matrix D_i,
sets a threshold, compares values of respective coordinates, and converts them into a pulse matrix to be used as an input of a pulse neural network,
authenticates identity using the voiceprint signal when a user inputs a voice signal, and grants authority to execute a corresponding command if authentication is passed,
if authentication fails, provides an interface on the user terminal for the user to select whether they are a new user, and
controls to deny access to the system if no user input is received.

10. The system according to claim 1, wherein, when the instructions are executed by the processor, the system:
receives a dynamic authentication character generated according to a user's voice payment request, wherein the dynamic authentication character is randomly selected from a fixed-length character data template and transmitted to the user, and provides guide information to the user,
collects a voice input comprising voice information corresponding to user information and the dynamic authentication character,
displays a message to the user to perform voice input before collecting the voice input,
displays a message to the user to select and confirm multiple pronunciations when collecting the voice input,
displays a message to the user to confirm an input result after collecting the voice input,
performs identity authentication and voiceprint authentication according to the voice input comprising the voice information corresponding to the dynamic authentication character and user information, and confirms the user's bank card information,
if the identity authentication and the voiceprint authentication are passed, acquires seller's information and a transaction amount, and
performs payment verification by inputting a password, and if the payment verification is passed, causes the transaction amount to be paid to a seller corresponding to the seller's information.
